(19) United States
(12) Patent Application Publication
(10) Pub. No.: US 2005/0027816 A1
(43) Pub. Date: Feb. 3, 2005

(54) Information technology computing support quality management system model

(76) Inventors: Guy B. Olney, Sammamish, WA (US); Erika A. Porter, Kirkland, WA (US)

Correspondence Address: HARNESS, DICKEY & PIERCE, P.L.C., P.O. BOX 828, BLOOMFIELD HILLS, MI, 48303, US

(21) Appl. No.: 10/629,727

(22) Filed: Jul. 29, 2003

(51) Int. Cl. G06F 15/16

(52) U.S. Cl. 709/217

(57) ABSTRACT

A method of modeling computing support services and processes generally includes defining a computing support service as either a computing transaction or a change to a computing environment; and defining a computing support process as one of an information delivery process for delivering computing transactions to end users, an environment build process for delivering changes to a computing environment which delivers computing transactions, a process for finding and fixing service and process defects associated with the information delivery process, and a process for finding and fixing service and process defects associated with the environment build process.

### COPYRIGHT NOTICE

A portion of the disclosure of this document contains material that is subject to copyright protection. The copyright owner has no objection to the facsimile reproduction by anyone of the patent disclosure, as it appears in the U.S. Patent and Trademark Office patent files or records, but otherwise the copyright owner reserves all copyright rights whatsoever.

### FIELD

The invention relates generally to information technology (IT) computing support and more particularly to IT computing support quality management system models.

### BACKGROUND

Traditionally, IT computing support has been defined as a widely disassociated set of services. This is at least partly due to the lack of an industry standard for computing support processes and to the strong organizational segregation, a result of the various component technologies and the different technical skills required for them. This strong organizational segregation generally results in segregated service definitions which have confused customers and hindered attempts at process management and quality improvement of IT computing support.

Previous attempts to develop standardized computing support process definitions have had limited success in their implementation due to a lack of integration. Information Technology Infrastructure Library (ITIL) is an widely accepted approach to IT Service Management. However, ITIL includes voluminous information at a relatively low level of detail, which makes managing IT computing support with ITIL quite difficult. This is even more difficult when the IT computing support management must comply with a quality management standard, like ISO (International Standards Organization) 9001:2000 a worldwide commercial quality standard.

Quality management standards, like ISO 9001:2000, have numerous requirements in order to guarantee continuous process improvement and ensure that a product or service which does not meet the customers' requirements is restored to acceptable limits and action is taken to prevent recurrence. The numerous requirements of quality management standards coupled with the voluminous information of ITIL make implementing a quality management standard for IT computing support modeled with ITIL a highly complex, labor intensive, and costly endeavor.

### SUMMARY

In one preferred embodiment, the invention provides a method of modeling computing support services and processes that generally includes defining a computing support service as either a computing transaction or a change to a computing environment; defining a computing support process as one of an information delivery process for delivering computing transactions to end users, an environment build process for delivering changes to a computing environment which delivers computing transactions, a process for finding and fixing service and process defects associated with the information delivery process, and a process for finding and fixing service and process defects associated with the environment build process.

In another preferred embodiment, the invention provides a method of managing computing support services and processes that generally includes defining a computing support service as either a computing transaction or a change to a computing environment; defining a computing support process as one of an information delivery process for delivering computing transactions to end users, an environment build process for delivering changes to a computing environment which delivers computing transactions, a process for finding and fixing service and process defects associated with the information delivery process, and a process for finding and fixing service and process defects associated with the environment build process; and managing quality of the information delivery and environment build processes by performing the processes for finding and fixing service and process defects.

In another preferred embodiment, the invention provides a system for managing computing support services and processes. The system includes an information delivery process for delivering computing transactions to end users and an environment build process for delivering changes to a computing environment which delivers computing transactions. The system also includes a process for finding and fixing service and process defects associated with the information delivery process, and a process for finding and fixing service and process defects associated with the environment build process. Each of the computing support processes are defined as a portion of one of the information delivery process, the environment build process, the process for finding and fixing service and process defects associated with the information delivery process, and the process for finding and fixing service and process defects associated with the environment build process. Each of the computing support services are defined as either a computing transaction or a change to a computing environment.

Further areas of applicability of the invention will become apparent from the detailed description provided hereinafter. It should be understood that the detailed description and specific examples, while indicating at least one exemplary embodiment of the invention, are intended for purposes of illustration only and are not intended to limit the scope of the invention.

### BRIEF DESCRIPTION OF THE DRAWING

The invention will be more fully understood from the detailed description and the accompanying drawing, wherein:

FIG. 1 is a process flow diagram of a IT computing support model according to an exemplary embodiment of the invention and illustrating interrelationship between the model and processes performed by external suppliers; and

FIG. 2 is a more detailed process flow diagram of the IT computing support model shown in FIG. 1 according to an exemplary embodiment of the invention;

FIG. 3 is a process flow diagram of a IT computing support model illustrating various computing support processes, as defined with Information Technology Infrastructure Library taxonomy, mapped to the model according to an exemplary embodiment of the invention; and

FIG. 4 is a more detailed process flow diagram of the IT computing support model shown in FIG. 3 according to an exemplary embodiment of the invention.

Corresponding reference numerals indicate corresponding parts throughout the several views of the drawings.

### DETAILED DESCRIPTION OF THE EXEMPLARY EMBODIMENTS

According to one aspect, the invention provides a method of modeling Information Technology (IT) computing support services and processes. In one embodiment, the method generally includes defining a computing support service or product as either a computing transaction or a change to a computing environment; defining a computing support process as one of an information delivery process for delivering computing transactions to end users, an environment build process for delivering changes to a computing environment which delivers computing transactions, a process for finding and fixing service and process defects associated with the information delivery process, and a process for finding and fixing service and process defects associated with the environment build process. The environment build process with its delivery of a change to the computing environment, in effect, changes the information delivery process.

The find and fix processes associated with the information delivery and environment build processes preferably restore, analyze, and improve the services/products and processes of the information delivery and environment build processes. The quality of the information delivery and environment build processes and the respective services delivered thereby can be managed through corrective action, data analysis, and preventive action, which preferably ensures generally continuous process improvement in at least some embodiments of the invention. At least some embodiments of the invention fulfill requirements of commonly accepted quality management standards (e.g., ISO 9001:2000) pertaining to management responsibility, resource management, and non-design portions of product realization.

As used herein, a computing transaction refers to and includes information delivered through or by a computing system or environment. Computing transactions can include but are not limited to discrete transactions. Computing transactions can also include but are not limited to information delivered to another computer, a terminal or a printer. Exemplary computing transactions can include, but are not limited to, data, voice, audio, and video information whose delivery is done by or controlled by a computing system.

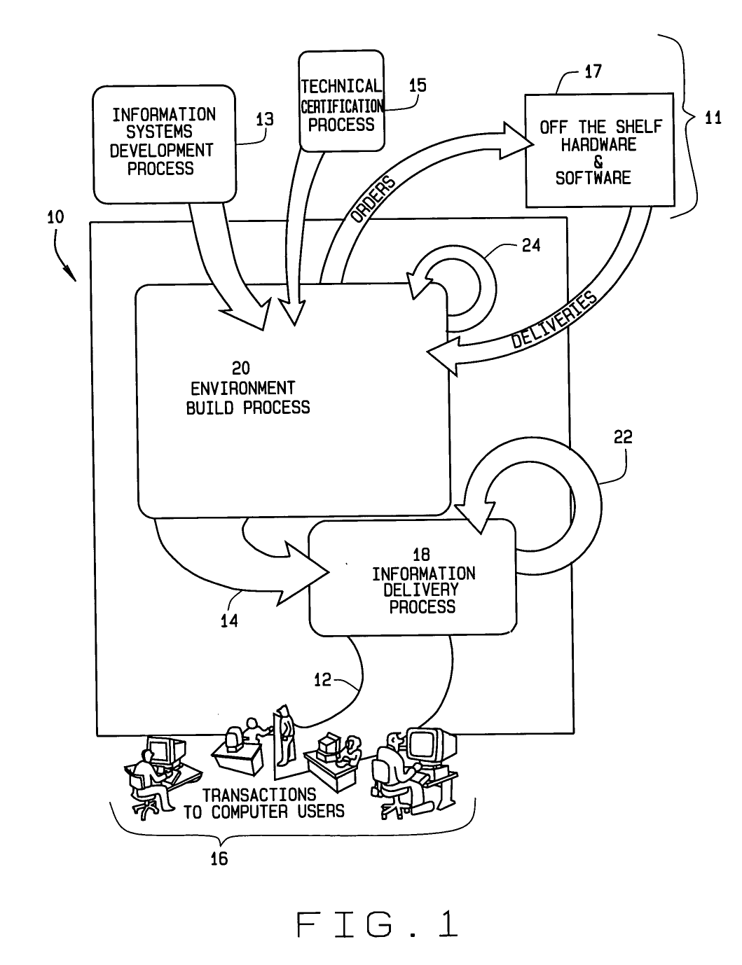

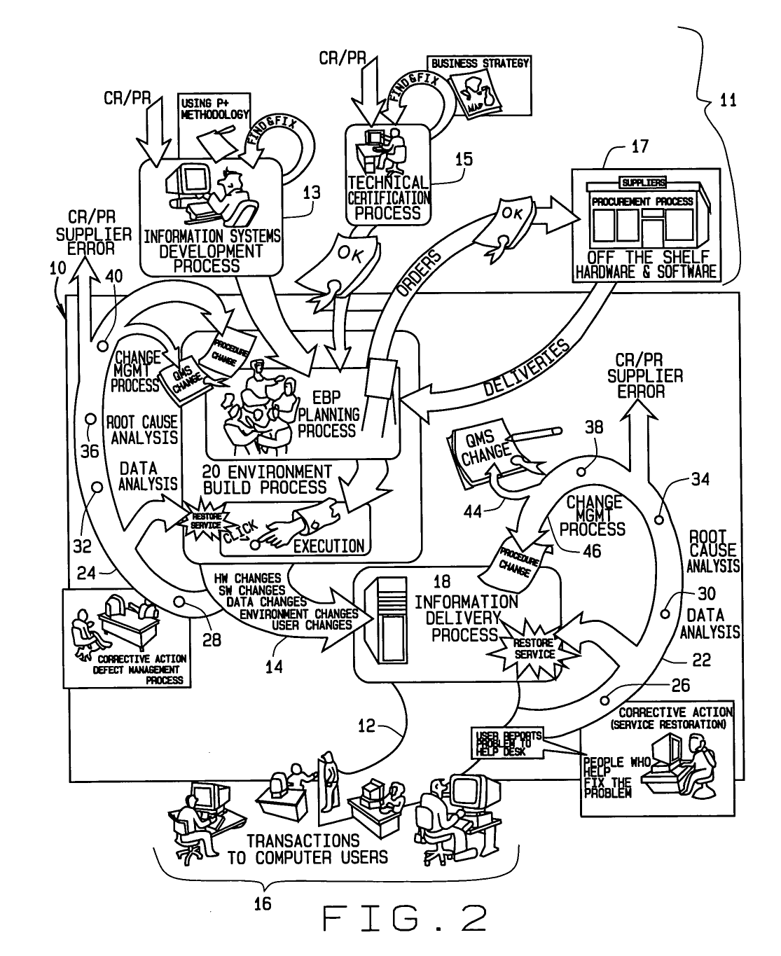

FIGS. 1 and 2 illustrate an IT computing support model 10 according to an exemplary embodiment of the invention. FIGS. 1 and 2 also illustrate the interrelationship of the model 10 with various processes performed by external suppliers 11, such as information system or application development processes 13, technical certification processes 15, and off-the-shelf software and hardware procurement processes 17. In the figures, the arrows represent the flow of work.

As shown, the model 10 defines two computing support services or products, namely computing transactions 12 and changes 14 to the computing system or environment which delivers computing transactions to end users 16.

The model 10 also defines two top level processes 18 and 20, each of which delivers a corresponding one of the defined services 12 and 14. More specifically, the model 10 includes an information delivery process (IDP) 18 for delivering computing transactions 12. The model 10 also includes an environment build process (EBP) 20 for delivering changes 14 to the computing environment. IDP 18 and EBP 20 are interrelated and mutually dependent in the exemplary embodiment. The model 10 also includes processes 22 and 24 (described below) for finding and fixing service and process defects associated with IDP 18 and EBP 20.

The lower level computing support details (e.g., other computing support processes and their deliverables) are defined as a portion of IDP 18, EBP 20, or the find and fix processes 22 and 24 associated with IDP 18 and EBP 20. The model 10 identifies IDP customers as computing end users 16 and identifies EBP customers as the owner(s) of the computing environment.

Computing transactions 12, which are delivered by IDP 18 within a computing environment created by EBP 20, may be executed either online or offline.

Online computing transactions refer to and include unscheduled transactions which are initiated by an end user request (e.g., a keyboard stroke, a mouse click, etc.). Preferably, delivery of the online transactions is completely automated and transparent to end users, that is, except for an end user making the request for the transaction.

Offline computing transactions refer to and include scheduled transactions such as data backups, batch jobs, and scheduled startups and shutdowns of the computing environment. Preferably, delivery of offline transactions is mostly automated and transparent to end users, with the schedules for the offline transactions being negotiated (e.g., planned, coordinated, and managed) by the environment build process 20.

EBP 20 delivers changes 14 to computing environments. A computing environment can include various combinations of hardware, software, network communications and procedures for delivering computing transactions to end users. In certain embodiments, EBP 20 includes planning, building, testing and deploying of computing environments. For example, EBP 20 can receive application software and computing system designs from external supplier organizations 11, along with plans for end user implementation. EBP 20 may then synchronize and execute the plans and ensure that the execution achieves the desired goals.

Changes 14 to a computing environment deliverable by EBP 20 can include hardware changes (e.g., adding or removing a server or disk, etc.), software changes (e.g., adding or removing software, such as a planned major release, emergent release, or operating system), user changes (e.g., adding new users to or removing existing users from the computing environment), environment changes (commissioning or decommissioning a computing environment), and data changes (adding data to or removing data from a computing environment). A completed delivery by EBP 20 may involve more than one and sometimes all of the changes listed above.

The processes 22 and 24 for finding and fixing service and process defects associated with IDP 18 and EBP 20 will now be described in accordance with an exemplary embodiment. It is understood that the descriptions of the find and fix processes 22 and 24 herein are for illustrative purposes only and that those skilled in the art will recognize modifications or variations which might be made without departing from the inventive concept.

In the illustrated embodiment, the find and fix loops 22 and 24 can ensure control of the delivery and unit costs of the products and services through corrective action 26, 28, data analysis 30, 32, and preventive action 34, 36. Preferably, the find and fix processes 22 and 24 ensure generally continuous process improvement 38, 40.

An exemplary corrective action 26 taken during the find and fix loop 22 can include a service restoration process in which a help desk repairs failed computing transactions occurring within IDP 18. The help desk can be triggered by an end user calling the help desk, an alarm, or monitoring. To create a record of the IDP corrective action, the help desk may document service problems in a ticket, and may enter the solution used to resolves the problem into the same ticket. In which case, the ticket thus becomes the entire record of the corrective action. If a supplier has provided a defective deliverable that caused the problem, a Change Request/Problem Report (CR/PR) may be used to notify that supplier of the deficiency.

An exemplary corrective action 28 taken during the find and fix loop 24 can include a defect management process in which errors occurring within EBP 20 are reported and repaired. The defect management process may include identifying defective deliverables, products or desktop procedures that occur during the planning or event portion of EBP 20. To create a record of the EBP corrective action, an EBP defect and its resolution can be entered into a tracking database to generate a quality record or defect ticket. Defect tickets can be assigned to the EBP job role responsible for the faulty deliverable for their evaluation and resolution. Defect tickets may also be written against the supplier product to allow the supplier to evaluate and resolve the defect, generally resulting in a CR/PR being written.

Exemplary data analysis processes 30 and 32 for the find and fix processes 22 and 24, respectively, can include daily management for determining when a change is needed to ensure control of variation and generally continuous improvement. Daily management decisions can be based on the review of quality data, cycle time data, unit cost data, reactive trends, and productivity data. This data can be generated during the corrective action and/or preventive action.

Daily management can include reviewing corrective action records, cycle time measurements, and unit cost to ensure that discrepancies are resolved in accordance with customer expectations. Variations over time may also be reviewed to identify adverse trends. Daily management can also serve as the proactive portion of the preventive action processes 34 and 36 as the trigger for the root cause analysis processes. IT management may initiate a root cause analysis to investigate and resolve adverse trends or other problems elucidated through the data analysis.

For the find and fix process 22 associated with IDP 18, data analysis 30 can include various actions that ensure on-time delivery of computing transactions and which meet the customer's requirements. Data analysis 32 for the find and fix process 24 can include various actions that ensure on-time delivery of a changed computing environment and which meets the customer's requirements.

Preventive action processes 34 and 36 for the find and fix loops 22 and 24 can include root cause analysis (RCA) processes. An exemplary RCA can involve evaluation of nonconformance data from the corrective action processes to identify significant problems, adverse trends, and repetitive errors. An exemplary RCA can include determining why a problem exists and what actions can be taken to eliminate, or at least reduce, the problem and prevent the problem from recurring, thereby ensuring generally continuous improvement of the services delivery by and processes of the information delivery and environment build processes 18 and 20.

An RCA process can be triggered by a recurring problem, adverse trends in corrective action data, and/or by management.

The preventive action processes 34 and 36 are preferably integrated with one another to accommodate the exchanging of problem ownership and implementing of process and procedural changes in IDP 18 and EBP 20 as well as in their common infrastructure.

The generally continuous process improvement portions 38 and 40 associated with IDP 18 and EBP 20 can stipulate analysis of data (collected through corrective actions, preventive actions, and daily management) to determine when change is needed. Adverse data trends may reveal a need to change either a product and/or a process.

To change a product, a CR/PR can be written and delivered to a supplier. The CR/PR may then result in changes that are routed through EBP 20, thereby resulting in changes to IDP 18. Improved products from suppliers can be installed through EBP 20 in order to change IDP 18.

To make a quality management system (QMS) process change or a desktop procedure change, the generally continuous process improvement portions 38 and 40 can employ a change management process. Records are preferably kept of both types of changes.

Accordingly, the exemplary embodiment recognizes that the system has defined numerous records, including, but not limited to, IDP corrective action records (tickets), EBP corrective action records (defect tickets), and IDP and EBP continuous process improvement records (e.g., records of QMS process changes and records of desktop procedure changes). These records are proof that work is being done and that the quality management system is operational.

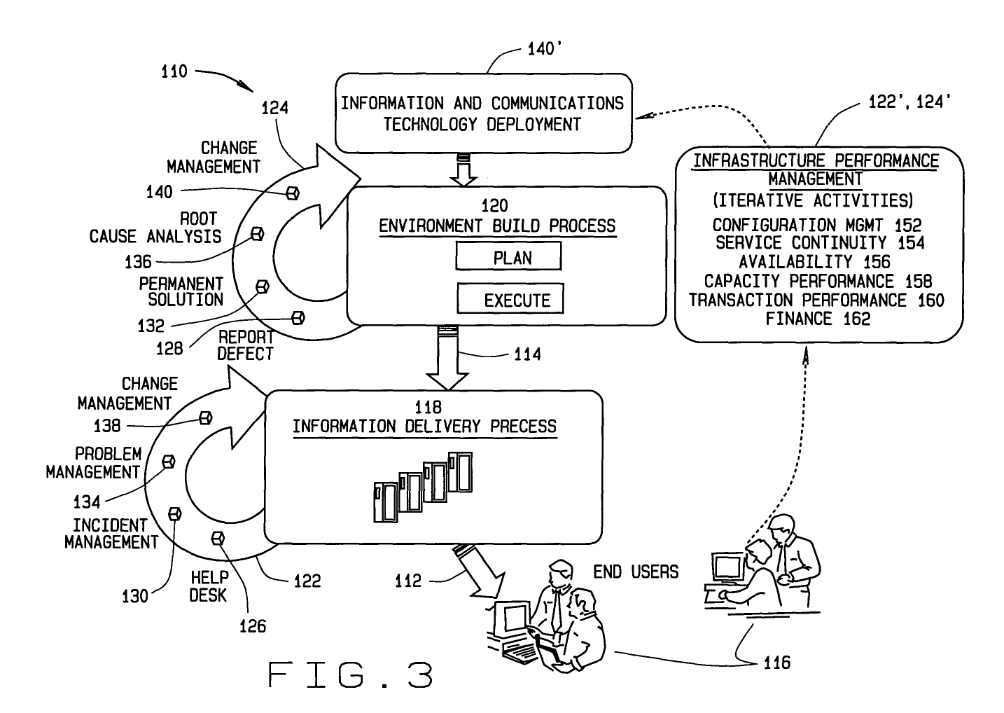

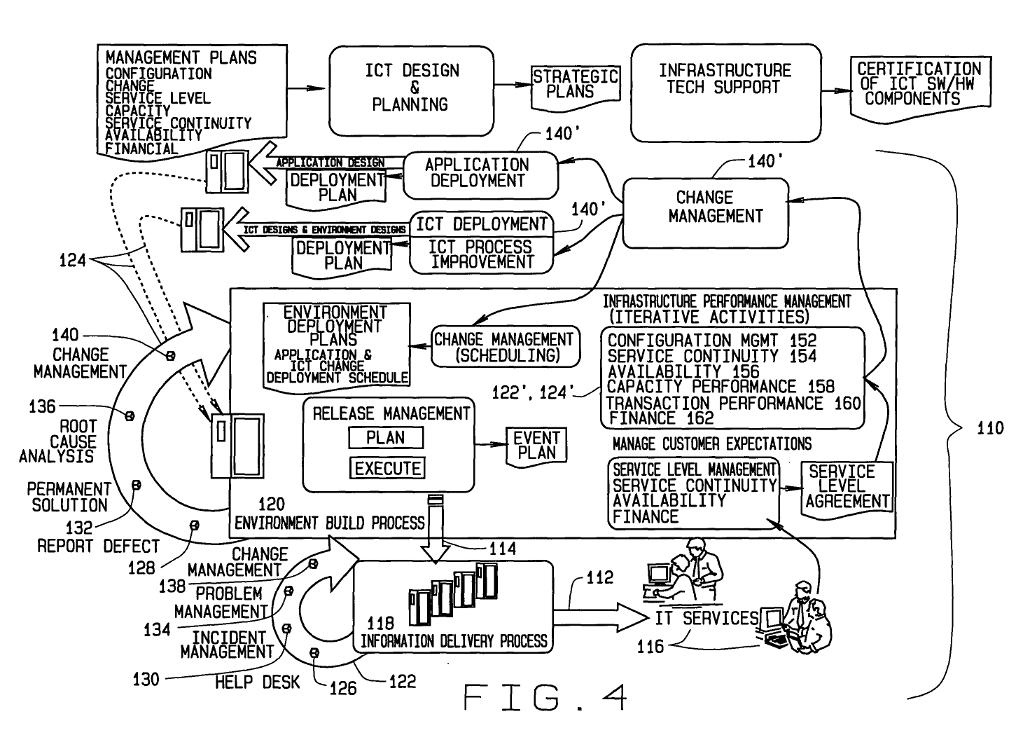

FIGS. 3 and 4 illustrates an exemplary way in which various midlevel and low-level details and processes as described by terminology from Information Technology Infrastructure Library (ITIL) can be mapped directly to a IT computing support model 110 according to an exemplary embodiment.

As shown in FIGS. 3 and 4, the model 110 defines two computing support products/services, specifically, computing transactions 112 and changes 114 to the computing systems or environments which delivers computing transactions to end users 116. The model 110 also defines an information delivery process (IDP) 118 for delivering computing transactions 112, and an environment build process (EBP) 120 for delivering changes 14 to computing environments.

Find and fix processes 122 and 124 are associated with IDP 118 and EBP 120, respectively, for restoring, analyzing and improving the services/products and processes of IDP 118 and EBP 120. The processes 122 and 124 can respectively include corrective action 126 and 128, data analysis 130 and 132, and preventive action 134 and 136, thereby ensuring generally continuous process improvement 138 and 140. The generally continuous process improvement 140 associated with EBP 120 can also include an information and communications technology deployment 140′.

With further reference to FIGS. 3 and 4, the find and fix processes 122 and 124 can also include infrastructure performance management 122′ and 124′. The infrastructure performance management 122′ and 124′ can include various iterative activities, some or all of which may occur on a regular (e.g., daily) basis regardless of whether an error or failure is observed. The iterative activities include configuration management 152, service continuity 154, availability 156, capacity performance 158, transaction performance 160, and finance 162.

In the model 110, each lower-level computing service can be defined as either a computing transaction or a change to a computing environment. Further, the model 110 can define each lower-level computing support process as a portion of IDP 118, EBP 120, the process 122 for finding and fixing service and process defects associated with IDP 118, or the process 124 for finding and fixing service and process defects associated with EBP 120.

In another preferred embodiment, the invention provides a method of managing computing support services and processes that generally includes defining a computing support service as either a computing transaction or a change to a computing environment; defining a computing support process as one of an information delivery process for delivering computing transactions to end users, an environment build process for delivering changes to a computing environment which delivers computing transactions, a process for finding and fixing service and process defects associated with the information delivery process, and a process for finding and fixing service and process defects associated with the environment build process; and managing quality of the information delivery and environment build processes by performing the processes for finding and fixing service and process defects.

In at least one embodiment of the method of managing, performing the find and fix processes can include corrective action, data analysis, and preventive action, which ensures generally continuous process improvement. Additionally, the method of managing can further include defining each lower-level computing service as either a computing transaction and a change to a computing environment; and defining each lower-level computing support process as a portion of one of the information delivery process, the environment build process, the process for finding and fixing service and process defects associated with the information delivery process, and the process for finding and fixing service and process defects associated with the environment build process.

In another embodiment, the invention provides a system for managing computing support services and processes. The system includes an information delivery process for delivering computing transactions to end users and an environment build process for delivering changes to a computing environment which delivers computing transactions. The system also includes processes for finding and fixing service and process defects associated with the information delivery and environment build processes. Each of the computing support processes is defined as a portion of the information delivery process, the environment build process, the process for finding and fixing service and process defects associated with the information delivery process, or the process for finding and fixing service and process defects associated with the environment build process. Each of the computing support services is defined as either a computing transaction or a change to a computing environment.

Accordingly, embodiments of the invention provide an integrated top level process model that accounts for IT computing support processes and services in a relatively easy-to-understand manner. A IT computing support model in accordance with the present invention allows for simplified application of statistical quality control techniques and also allows for accurate, efficient, integrated, and understandable measurements of quality, unit cost and cycle time. Models of the present invention also allow reductions in the amount of data IT managers have to analyze to determine how an entire IT business is operating.

IT computing support models of the present invention also have the flexibility to be applied across a wide range of businesses and organizations that rely on IT infrastructure. In certain embodiments, the various components of ISO 9001:2000 components map directly into the IT computing support model, thereby providing a relatively simple and cost effective implementation strategy for ISO 9001:2000.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A method of modeling computing support services and processes, the method comprising:
defining a computing support service as one of a computing transaction and a change to a computing environment;
defining a computing support process as one of:
an information delivery process for delivering computing transactions to end users;
an environment build process for delivering changes to a computing environment which delivers computing transactions;
a process for finding and fixing service and process defects associated with the information delivery process; and
a process for finding and fixing service and process defects associated with the environment build process.

2. The method of claim 1, wherein defining a computing support process includes defining each lower-level computing support process as a portion of one of the information delivery process, the environment build process, the process for finding and fixing service and process defects associated with the information delivery process, and the process for finding and fixing service and process defects associated with the environment build process.

3. The method of claim 1, wherein defining a computing support service includes defining each lower-level computing service as one of a computing transaction and a change to a computing environment.

4. The method of claim 1, further comprising managing quality of the information delivery and environment build processes by performing the processes for finding and fixing service and process defects.

5. The method of claim 1, wherein the processes for finding and fixing service and process defects include corrective action, data analysis, and preventive action.

6. The method of claim 5, wherein corrective action for the information delivery process includes service restoration.

7. The method of claim 5, wherein corrective action for the environment build process includes defect management.

8. The method of claim 5, wherein data analysis includes analyzing data generated by corrective action and preventive action.

9. The method of claim 8, wherein the data includes quality data, cycle time data, unit cost data, reactive trends, and productivity data.

10. The method of claim 5, wherein preventive action includes root cause analysis.

11. The method of claim 5, wherein the managing ensures generally continuous process improvement.

12. The method of claim 11, wherein the generally continuous process improvement includes:
a change management process for changing a process; and
a process for changing a product including advising a supplier of a defective product, receiving an improved product from the supplier, and installing the improved product to the computing environment through the environment build process.

13. The method of claim 4, wherein the managing includes generating a record.

14. The method of claim 1, wherein the processes for finding and fixing service and process defects include an infrastructure performance management process.

15. The method of claim 1, further comprising defining at least one computer support process as defined by Information Technology Infrastructure Library taxonomy as a portion of one of the information delivery process, the environment build process, the process for finding and fixing service and process defects associated with the information delivery process, and the process for finding and fixing service and process defects associated with the environment build process.

16. A method of managing computing support services and processes, the method comprising:
defining a computing support service as one of a computing transaction and a change to a computing environment;
defining a computing support process as one of:
an information delivery process for delivering computing transactions to end users;
an environment build process for delivering changes to a computing environment which delivers computing transactions;
a process for finding and fixing service and process defects associated with the information delivery process; and
a process for finding and fixing service and process defects associated with the environment build process;
managing quality of the information delivery and environment build processes by performing the processes for finding and fixing service and process defects.

17. The method of claim 16, wherein the performing the processes for finding and fixing service and process defects includes corrective action, data analysis, and preventive action.

18. The method of claim 17, wherein the managing ensures generally continuous process improvement.

19. The method of claim 16, wherein defining a computing support process includes defining each lower-level computing support process as a portion of one of the information delivery process, the environment build process, the process for finding and fixing service and process defects associated with the information delivery process, and the process for finding and fixing service and process defects associated with the environment build process.

20. The method of claim 16, wherein defining a computing support service includes defining each lower-level computing service as one of a computing transaction and a change to a computing environment.

21. A system for managing computing support services and processes, the system including:
an information delivery process for delivering computing transactions to end users;
an environment build process for delivering changes to a computing environment which delivers computing transactions;
a process for finding and fixing service and process defects associated with the information delivery process; and
a process for finding and fixing service and process defects associated with the environment build process;
each of the computing support processes being defined as a portion of one of the information delivery process, the environment build process, the process for finding and fixing service and process defects associated with the information delivery process, and the process for finding and fixing service and process defects associated with the environment build process; and
each of the computing support services being defined as one of a computing transaction and a change to a computing environment.

22. The system of claim 21, wherein the information delivery process is generally automated and transparent to the end users.

23. The system of claim 21, wherein a change to the computing environment includes one or more of a hardware change, a software change, a data change, a user change, and a computing environment change.

24. The system of claim 21, wherein the processes for finding and fixing service and process defects include corrective action, data analysis, and preventive action.

25. The system of claim 24, wherein the processes for finding and fixing service and process defects ensures generally continuous process improvement.
